(19) United States
(12) Patent Application Publication
(10) Pub. No.: US 2011/0141363 A1
(43) Pub. Date: Jun. 16, 2011

(54) MULTIMEDIA TELEVISION PROGRAM ANNOUNCEMENT SYSTEM AND METHODS

(75) Inventor: John R. Wullert, II, Martinsville, NJ (US)

(73) Assignee: TELCORDIA TECHNOLOGIES, INC., Piscataway, NJ (US)

(21) Appl. No.: 12/637,118

(22) Filed: Dec. 14, 2009

(51) Int. Cl. H04N 5/45; H04N 5/50; H04N 5/445

(52) U.S. Cl. 348/565; 348/570; 725/38; 725/134; 348/E05.112; 348/E05.097

(57) ABSTRACT

A system and method are provided for television program announcements, involving a television; a storage device connected to the television that stores multimedia summaries of a plurality of television programs, including the channel and time of display of the program for which it is a summary; the capacity to change channels; and a processor program to sense when the television has been connected to a new channel and to select and display on that television the multimedia summary of the program being presented on the new channel at the time of the connection of the television to the new channel.

### BACKGROUND

1. Technical Field

The system and methods disclosed herein relate to the field of television programming and, more specifically, to a system and methods for providing program announcements.

2. Description of the Related Art

People watching television often search through the available channels, looking for a program of interest. With digital cable systems offering a large number of channels, this can be problematic, in part because it is hard to remember which station is associated with which channel. In addition, as a user switches to a new channel, there may be at that time a commercial or a portion of a program being presented that makes it hard to determine what the program content actually is. Thus, the user is forced to either wait for a period of time, namely, until the commercial is over or the program content comes to a point where it is recognizable to the user, or the user may simply skip over the channel to the next one, potentially missing a program of interest.

Digital cable systems have addressed this problem by inserting a textual description field into the screen, which appears when the user changes channels. This textual description can include the channel number, as well as the station and program title information. This service readily provides the channel and station information. However, the program title alone may not be sufficient in some cases to describe the program being displayed. For example, the title of a movie gives some information about its content, but that title is likely to be of little use to people who have not seen or heard of the movie.

In addition, most digital cable systems broadcast a programming guide that contains the station and program title information along with a brief textual summary of the program content. If this information were deemed sufficient to identify the program content to a point where it would allow a viewer to make a channel selection with a high degree of confidence, the viewer would probably be using the programming guide instead of surfing through the channels, as is often the case, to find a program of interest.

### SUMMARY

The present invention provides an aural and/or visual—rather than a simply textual—introduction to program content. In the preferred embodiment, a multimedia program description, including audio, still pictures, video, and/or streaming text, is downloaded into a television or set-top box and displayed when the user changes channels.

In one embodiment, the invention comprises a television program announcement system including a television; a storage device connected to the television that stores multimedia summaries of television programs, including information detailing the channel and time of display of the program for which each is a summary; a channel selector; and a processor programmed to sense when the television has been connected to a new channel, and to select and display on that television the multimedia summary of the program being presented on the new channel at the time of the connection of the television to that new channel.

Preferably, the storage device is located in a set-top box connected to the television. Moreover, in one embodiment, the invention further includes a receiver coupled to the storage device that is adapted to receive the multimedia summaries transmitted from a remote location. Thus, the system may include a transmitter located at that remote location adapted to broadcast the multimedia summaries periodically to the storage device, separately from the program content of the programs.

The multimedia summaries of the present invention preferably include an announcement of the current program in the form of a text stream, audio, still images, and/or video. The multimedia summaries may, in the alternative, include an audio and/or video segment of the corresponding program being summarized.

In another embodiment, the present invention comprises a television program announcement method including the steps of: loading a storage device connected to a television with multimedia summaries of a plurality of television programs that have attached to them information detailing the channel and time of the display of the program for which each is a summary; sensing when the television has been connected to a new channel; and selecting and displaying on the television the multimedia summary of the program being presented on the new channel at the time of the connection of the television to that channel.

In a still further alternative embodiment of the present invention, there is provided a computer-readable storage medium comprising instructions that, when executed in a system, cause the system to perform a television program announcement method, the method comprising the steps of: loading a storage device connected to a television with multimedia summaries of the plurality of television programs that have attached to them information detailing the channel and time of display of the program for which each is a summary; sensing when the television has been connected to a new channel; and selecting and displaying on the television a multimedia summary of the program being presented on the new channel at the time of the connection of the television to that new channel.

It is important to understand that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate various embodiments. In the drawings:

FIG. 1 illustrates the system architecture for a multimedia television program announcement system utilizing the principles of the present invention.

FIG. 2 illustrates the transmission of program announcements using side channels in digital television signals.

FIG. 3 illustrates both the functional elements and data structures utilized by one embodiment of the present invention.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented here. While the techniques and embodiments will primarily be described in the context of the accompanying drawings, those skilled in the art will further appreciate that the techniques and embodiments can also be practiced in other electronic devices or systems.

Reference will now be made in detail to exemplary embodiments of the present invention, examples of which are illustrated in the accompanying drawings.

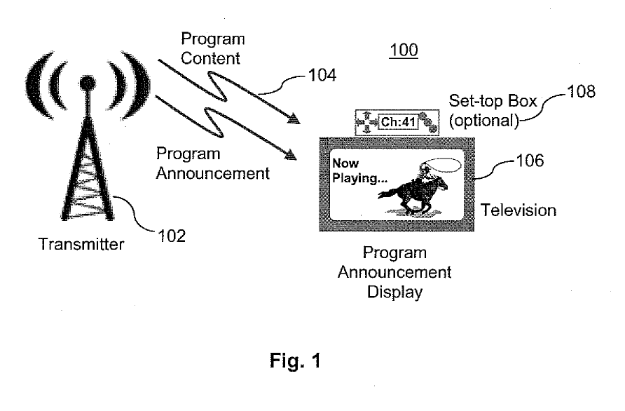

The basic elements of the system 100, as shown in FIG. 1, are the same used in standard television communication systems. These elements include a transmitter 102, a transmission medium 104, a television 106, and an optional set-top box 108. Transmitter 102, which is shown to be a wireless broadcast antenna in FIG. 1, could also be a cable or fiber-optic head end or satellite transmitter. Each of these technologies has its own corresponding transmission medium, such as over the air, coaxial cable, optical fiber, or any other medium well known to those skilled in the art. The received programming signal may, as is also well known, pass through set-top box 108 on its way to television 106. Components of the programming signal may be stored in set-top box 108.

A key difference that the multimedia television program announcements of the present invention make to this traditional television communication system is that when the user changes a channel, rather than seeing the program content currently being transmitted on the new channel, with or without a simple text message indicating the channel and title of that programming content, the user receives an announcement of the program currently being broadcast. Preferably, this announcement is in the form of an audio announcement, a still image, a video clip, a text stream, or a combination of these multimedia options. After this announcement is presented, the program content currently being broadcast is presented to the user.

There are several methods through which this functionality can be implemented. As shown in FIG. 1, the program announcement information could be sent separately from the program content through transmission medium 104. The separate path for the program announcement information could be a dedicated transmission channel. For example, in a digital cable system with a thousand channels, one or more channels could be set aside and used to transmit the program announcement information for all the remaining channels. Once transmitted, these announcements could be stored in television 106 or in set-top box 108 to be used when a user switches channels.

If each announcement consists of a full-resolution, five-second audio/video segment, then a single channel would support transmission of about 700 announcements, assuming twelve five-second announcements retransmitted per minute. While this might not be sufficient to cover a thousand channels, in most digital cable systems, while there may be a thousand channels available, not all of them are in use. In addition, more than one channel can be used for the purpose of transmitting announcement information. Also, there are efficiency techniques that could be used to extend coverage.

The separate path could also be a portion of the broadcast of each individual channel. This could make use of side channels in the digital broadcast. These side channels can be used for transmitting auxiliary information. For example, U.S. Pat. No. 7,028,323 entitled, “System and Method for Delivering Rerun Video Programming on Non-HDTV Digital Side Channels,” proposes using the side channels of a digital television signal to deliver other programming that can be stored in a set-top box or television for later, non-real-time viewing.

While the non-real-time restriction is a result of limited bandwidth in the side channels, side channels will likely nevertheless support transmission of announcements, given the expected short duration of these announcements.

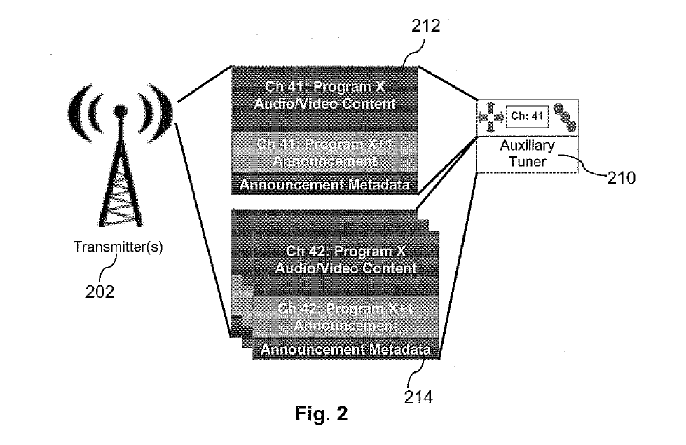

In limited bandwidth situations, the program announcements can be sent ahead of time. Specifically, as shown in FIG. 2, the program announcements 214 can be sent while program 212 is being aired in real time. To support this arrangement, set-top box 108 or television 106, as shown in FIG. 1, preferably has sufficient storage capacity and structures to store a current announcement and an upcoming announcement for each active channel.

In addition, program announcements 214 preferably are augmented with meta information that describes a time period corresponding to the announcement. In this case, referring back to FIG. 1, set-top box 108 or television 106 would preferably have at least one secondary tuner to retrieve the announcement information from channels other than the one the user is currently viewing. The primary tuner, which is used to extract the information for the program content the user is currently viewing, can also extract program announcements for that channel. The secondary tuner may be adjusted to scan through channels that the user is not currently viewing to extract the corresponding program announcements associated with those channels, or it may be adjusted to scan otherwise unused channels to extract program announcements transmitted on those channels.

If there are multiple auxiliary tuners, they may each scan a subset of the channels, increasing the effective bandwidth of the program announcement retrieval. This approach may be best suited for “over the air” broadcasting, in which case, there are many fewer channels to scan through than in cable and fiber-based systems.

If there is only a single secondary tuner available, there may be insufficient bandwidth to retrieve full-screen resolution of audio/video announcements for all available channels. To allow for situations where the channels used for transmitting the program announcements have limited data-carrying capability, the program announcements could be limited in size, such as by restricting the announcements to normal-definition video rather than high-definition video, possibly with an associated audio feed to limit the quantity of information that needs to be transmitted.

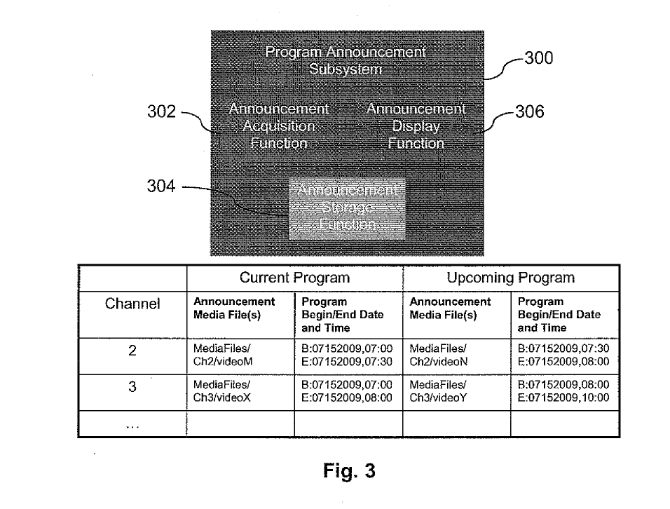

To implement the present invention, set-top box 108 or television 106 must be enhanced, in comparison to conventional systems, to extract, store, and properly display the program announcements. FIG. 3 illustrates both the function elements of such enhancements and the data structures that may be utilized. For example, FIG. 3 shows a program announcement subsystem 300 that includes announcement acquisition function 302, announcement storage function 304, and announcement display function 306.

Announcement acquisition function 302 is responsible for scanning the announcement transmissions for all the available channels and extracting the program announcement media and metadata for each one. The extracting mechanism for scanning will vary, depending on the means used for transmitting the program announcements, as described above. Each time announcement acquisition function 302 has extracted a program announcement and the corresponding metadata, it passes it to announcement storage function 304.

Announcement storage function 304 is responsible for storing, retrieving, and managing the program announcements and metadata. When announcement storage function 304 receives an announcement from announcement acquisition function 302, it compares the beginning and end date/time, and, if not related to a current program, stores the information, as shown by way of example, in the lower portion of FIG. 3, as an upcoming program. If the current date/time is between the beginning and end date/times, announcement storage function 304 stores the information as the current program.

Other information, such as the text of the title of the program, a short textual description of the program, a category for the program (e.g., sports, game shows, news broadcasts, etc.), and/or the viewer rating associated with the program could also be stored.

To manage the announcement data, announcement storage function 304 must periodically scan through the table of channel program announcement information, comparing the current date/time to the upcoming program's begin and end times. When the current date/time reaches the begin time of the upcoming program, announcement storage function 304 moves the upcoming program information into the current program column. “Upcoming Program” information column will then be filled during the next update from announcement acquisition function 302.

Given that few programs are shorter than thirty minutes in length, and that most programs begin and end on the hour or half hour, the period of such scanning could be synchronized to occur every half hour centered on or slightly before the half hour, when the programs are turning over. In terms of retrieval, announcement storage function 304 also preferably supplies the appropriate current program announcement media files to announcement display function 306 upon request.

The acquisition function could also be triggered by an indication in each channel's broadcast of when to start and when to stop recording. Thus, the summary could be just a portion of the program. To be useful, this would have to be an early part of the program, or sent before the program begins. Given that stations often broadcast “coming up next” announcements, the content of the announcement could be recorded and stored as the summary. This has the advantage of not requiring an extra channel or the use of side-channels for broadcasting the summaries.

The announcement display function 306 preferably is triggered by the action of the user changing channels. When the user changes the channel, announcement display function 306 receives an indication of the change, including the new channel number. Announcement display function 306 then queries announcement storage function 304 with the channel number and in return receives the corresponding current program announcement media file or files. As an option the television controls could have a “what are you watching” button, for example on the remote, that would pull up the program summary for the current channel.

Announcement display function 306 then transmits those files so that they are made visible and/or audible to the user. If announcement storage function 304 does not return any media files for a certain request, announcement display function 306 might, for example, transmit a default media file indicating that no information is available, perhaps including the new channel number and station identifier in conventional textual format, if such information is available.

Announcement display function 306 might also track the time between visits by a user to a particular channel and make a decision on whether or not to display the program announcement based on that time differential. If the user returns to the same channel in a few minutes or less, this might be an indication that the user is surfing between channels, or that the user has decided, based on previously viewing the program announcement, to watch the selected channel. Showing the program announcement in such a case may be considered repetitious to the user, and, thus, announcement display function 306 might be programmed to not display the program announcement, but rather to allow the user to go directly to the program content.

In situations where the user skips through many different channels quickly, this feature may be further enhanced by only recording the time between visits to the same channel if the user viewed the entire program announcement, or some large portion of it. Announcement display function 306 might also be triggered by direct user request, allowing the user to invoke the program announcement. This capability would be useful in cases where a second person enters the room and asks the user to identify the program that is being watched.

There are several means by which announcement display function 306 could display the program announced to the user. In one embodiment, the program announcement could be displayed over the entire screen in place of the current program being presented. Alternatively, the program announcement could be shown only on a portion of the screen, such as by using picture-in-picture technology. In this latter case, if the program announcement has an audio track, it could be played either instead of the program or mixed with it, for example, with the volume of the program reduced to enhance the user's ability to understand the mixed result.

The program announcements may also be used for various related purposes. For example, the program announcements could be used to insert a short advertisement or to highlight the identity of the sponsor of a particular program.

As an enhanced embodiment of the present invention, referring back to FIG. 3, announcement display function 306 could support user queries into the stored information. For example, the user could request to view upcoming programs. In this case, the user could, for example, push a button on the television remote control that would send a signal requesting the program announcement for the next program to be played on the channel currently viewed. This request would be delivered to announcement display function 306, which would request the upcoming program media files from announcement storage function 304, which would then be made available to the user.

Alternatively, the user could generate a query, such as for sporting events that are either ongoing or starting in the next conventional time slot, for example, in the next hour. The context of this query, which could be entered through an on-screen selection using a television remote control, would be passed to announcement display function 306. Announcement display function 306 would use the information to query announcement storage function 304. If announcement storage function 304 returns with matching results, announcement display function 306 would format them and display them to the user. One possibility is having the display in the form of thumbnail images with accompanying text describing the program title and time. The user could then select a program announcement to be viewed from the thumbnails.

It should be understood that if the bandwidth allows faster transmission of program announcements, the concept of the present invention could be extended to store the program announcements for multiple upcoming programs, which could be queried in this fashion.

It should further be understood that, in accordance with the teachings of the present invention, program announcement information can be sent either in real time, or transmitted in advance and stored until needed.

In the practice of a preferred embodiment of the present invention, a user can quickly determine what a particular program is all about by seeing, for example, a video image of a portion of the program and recognizing the set or actors involved. This is in contrast to simply turning to a new channel and viewing the ongoing programming because, at the time of arrival at the channel, a scene within the program may be unfamiliar to the user or the program may currently be in a commercial break.

The present invention, in one embodiment, permits the user to see a reasonable visual representation of the program each time he or she turns to a channel, regardless of the actual position in the program or the occurrence of commercial breaks. It also presents the opportunity for additional advertising by including sponsorship information in the program announcement.

With the present invention, rather than seeing just a simple set of digits describing the channel that has just been selected or a short textual description of the current program, the user would receive a multimedia presentation of the program currently showing on the channel. This increases the efficiency of the user in searching for a suitable program to watch in real time.

The user can also search for future programs and view the program announcements for those programs as well, providing a more attractive and informative means of determining what programs to watch at a future time.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention. For example, one or more steps of methods described above may be performed in a different order or concurrently and still achieve desirable results.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A television program announcement system comprising:
a television;
a storage device connected to said television containing multimedia summaries of a plurality of television programs that include the channel and time of display of the program for which it is a summary;
a channel selector; and
a processor programmed to:
sense when said television has been connected to a new channel; and
select and display on said television the multimedia summary of the program being presented on said new channel at the time of the connection of said television to said new channel.

2. The system of claim 1, wherein said storage device is located in a set-top box connected to said television.

3. The system of claim 2, further including a receiver coupled to said storage device and adapted to receive said multimedia summaries transmitted from a remote location.

4. The system of claim 2, further including a transmitter remotely located from said storage device adapted to broadcast said multimedia summaries periodically to said storage device, separately from the program content of said programs.

5. The system of claim 4, wherein said program content for said programs is sent by said transmitter in digital channels and said multimedia summaries are sent to said storage device in digital channels independent of said program content.

6. The system of claim 1, wherein said storage device is remotely located from said television and said system includes a transmitter adapted to broadcast said multimedia summaries in real time to said television.

7. The system of claim 1, wherein said multimedia summaries include an announcement of the current program in the form of a text stream, audio, still images, and/or video.

8. The system of claim 1, wherein said multimedia summaries include an audio/video segment of the corresponding program.

9. The system of claim 8, wherein said segment includes a clip from the program content of the corresponding program.

10. The system of claim 1, wherein said processor is further programmed to return said television to said program being presented on said new channel after displaying said multimedia summary.

11. The system of claim 1, further including a first receiver connected to receive program content in real time and a second receiver connected to receive said multimedia summaries.

12. The system of claim 11, wherein said multimedia summaries are received in non-real time.

13. The system of claim 1, wherein said multimedia summaries are displayed using picture-in-picture technology.

14. The system of claim 1, wherein said processor is further programmed to permit on-demand viewing of said multimedia summaries.

15. The system of claim 1, wherein said processor is further programmed to delay or preclude viewing of said multimedia summaries upon user request.

16. A television program announcement method comprising the steps of:
loading a storage device connected to a television with multimedia summaries of a plurality of television programs that have attached to them the channel and time of display of the program for which it is a summary;
sensing when said television has been connected to a new channel; and
selecting and displaying on said television the multimedia summary of the program being presented on said new channel at the time of the connection of the television to that new channel.

17. The method of claim 16, wherein said storage device is located in a set-top box connected to said television.

18. The method of claim 17, further including the step of coupling a receiver to said storage device and adapting it to receive said multimedia summaries transmitted from a remote location.

19. The method of claim 17, further including the steps of:
broadcasting said multimedia summaries periodically to said storage device from a transmitter remotely located from said television, said multimedia summaries being broadcast separately from the program content of said programs.

20. The method of claim 19, wherein said program content for said programs is sent by said transmitter in digital channels and said multimedia summaries are sent to said storage device in digital channels independent of said program content.

21. The method of claim 16, wherein said storage device is remotely located from said television and wherein said method further includes the step of broadcasting said multimedia summaries in real time to said television.

22. The method of claim 16, wherein said multimedia summaries include an announcement of the current program in the form of a text stream, audio, still images, and/or video.

23. The method of claim 16, wherein said multimedia summaries include an audio/video segment of the program content of the corresponding program.

24. The method of claim 23, wherein said segments include a clip from the program content of the corresponding program.

25. The method of claim 16, further including the step of returning said television to the program being presented on said new channel after presentation of said multimedia summary for said new channel and time.

26. The method of claim 16, further including the step of receiving program content in real time at a first receiver and receiving said multimedia summaries at a second receiver.

27. The method of claim 26, wherein said multimedia summaries are received in non-real time.

28. The method of claim 16, wherein said multimedia summaries are displayed using picture-in-picture technology.

29. The method of claim 16, further including the step of viewing said multimedia summaries on demand.

30. The method of claim 16, wherein said processor is further programmed to delay or preclude viewing of said multimedia summaries upon user request.

31. A computer-readable storage medium comprising instructions that, when executed in a system, cause the system to perform a television program announcement method, the method comprising the steps of:
loading a storage device connected to a television with multimedia summaries of a plurality of television programs that have attached to them the channel and time of display of the program for which it is a summary;
sensing when said television has been connected to a new channel; and
selecting and displaying on said television the multimedia summary of the program being presented on said new channel at the time of the connection of said television to said new channel.
